(19) United States
(12) Patent Application Publication
(10) Pub. No.: US 2007/0224693 A1
(43) Pub. Date: Sep. 27, 2007

(54) Interlocked hydrogen source for gas chromatography

(76) Inventor: Harry F. Prest, Santa Cruz, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/387,360

(22) Filed: Mar. 22, 2006

(51) Int. Cl. G01N 30/02

(52) U.S. Cl. 436/161

(57) ABSTRACT

A gas chromatograph uses hydrogen carrier gas supplied by a hydrogen source. At least one hydrogen sensor monitors the hydrogen level. The gas chromatograph communicates with the hydrogen source over a communication link. When the sensed hydrogen level exceeds a threshold, the gas chromatograph signals the hydrogen source to stop the flow of hydrogen.

### BACKGROUND OF THE INVENTION

Gas chromatography is a technique used to analyze a sample consisting of a mixture of compounds. A gas chromatograph separates a sample into its individual compounds, and is used in combination with a suitable detector to identify and measure those individual compounds.

The gas chromatograph relies on a carrier gas to carry the sample and its component compounds through a heated column. The sample compounds vaporize within the column, and travel through the column at different rates, depending on the physical properties of the compounds and their interaction with the column phase, etc. For instance, smaller molecules generally move through the column quicker than larger molecules basically due to their higher volatility. All of the molecules corresponding to a specific compound travel through the column at nearly the same rate and appear as a band of molecules (called a chromatographic peak) at the detector such as a mass spectrometer. Ideally there is no overlap between adjacent compound bands as they exit the column and enter the detector.

Helium is presently the most commonly used carrier gas since it is readily available and non-combustible. But, there are several drawbacks to using helium as a carrier gas. For example, the helium is an element and as such the supply is inherently limited. Helium can be expensive, especially in countries outside of the United States. Also, helium is stored in large, heavy tanks that are unwieldy to transport. Furthermore, the tanks may become dangerous projectiles if dropped or mishandled due to the highly compressed nature of the helium inside. Finally, there is some unwanted overlap between sample (compound) bands when helium is used as the carrier gas due to limitations on the resolving power in chromatographic separations using helium.

Hydrogen carrier gas is the solution to many of the problems associated with using helium. Hydrogen is plentiful, cheaper than helium, and can be easily generated from deionized water. Hydrogen has a faster chromatographic “run” time, too, allowing the gas chromatograph to process each sample more quickly. Hydrogen also has better chromatographic separation than helium, producing less overlap between the sample compound bands. Despite all these advantages, there is hesitance to adopt hydrogen as a carrier gas due to its high combustibility and potential for explosion.

There is a need, therefore, for a gas chromatography system using hydrogen carrier gas that is capable of detecting a hydrogen leak from the system, stopping the flow of hydrogen from the source in the event of a leak, and other intelligent activities to mitigate dangers and maintain analytical quality and sample processing.

### SUMMARY OF THE INVENTION

A gas chromatograph (GC) uses hydrogen carrier gas from a hydrogen source. The hydrogen source is in communication with the GC. An hydrogen sensor is capable of detecting the level of hydrogen in the ambient environment in which the system operates. The hydrogen sensor could also be located within the GC instrument itself. When the levels of hydrogen exceed an acceptable threshold, the GC shuts down the hydrogen source to stop the flow of hydrogen. Shutdown of the hydrogen source is also possible for other unsafe or “not-ready” conditions of the GC and its detection system.

### BRIEF DESCRIPTION OF THE DRAWINGS

FIG. 1 shows an embodiment of a gas chromatography system, made in accordance with the teachings of the present invention.

FIG. 2 shows a flow chart of a method for performing gas chromatography with hydrogen carrier gas, made in accordance with the teachings of the present invention.

### DETAILED DESCRIPTION

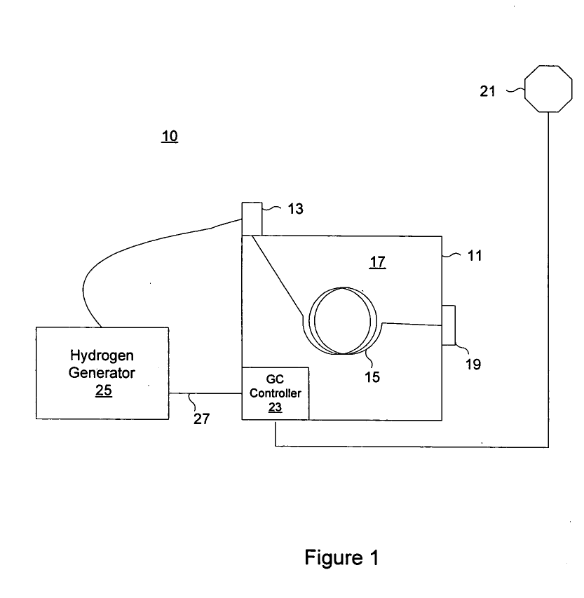

FIG. 1 shows a preferred embodiment of a gas chromatography system 10 made in accordance with the teachings of the present invention. The gas chromatography system 10 includes a gas chromatograph (GC) 11, a hydrogen generator 25, a hydrogen sensor 21, and a detector 19. The GC 11 has an injector 13 that injects a sample into a column 15. The column 15 is contained in a temperature-controlled oven 17. A GC controller 23 is the internal “brain” (e.g. a CPU or microprocessor) that runs the GC 11. It controls details such as the oven temperature, the injection of an analyte, the flow rate of the carrier gas, etc. Not shown in the drawing are the appropriate exhaust lines for hydrogen from such devices as the split port of the GC, or the mass spectrometer pumping system exhaust port, or other places germane to the specific GC and detector configurations.

A hydrogen generator 25 generates hydrogen gas from deionized water. Typically, the hydrogen generator 25 produces hydrogen gas and stores it in a reservoir for flowing to the GC 11. Future hydrogen generators 25 may produce hydrogen gas on demand and need very little or no reservoir at all. The hydrogen generator 25 is connected to the injector 13, sending hydrogen carrier gas through the injector 13, into the column 15, and to the detector 19. Depending upon the application and the nature of the analysis, the detector 19 can be a mass spectrometer, a flame ionization detector, a nitrogen phosphorus detector, a thermal conductive detector, an electron capture detector, photo-ionization detector, etc.

The GC controller 23 is connected to the hydrogen generator 25 by a communication link 27. The GC controller 23 is also coupled to the hydrogen sensor 21.

During normal operation of the GC 11, a sample is introduced into an injection zone (e.g. injector 13) and then heated, which causes the sample compounds to vaporize. The hydrogen gas carries the vaporized compounds into the column 15. The compounds travel through the column 15 at a rate primarily determined by their physical properties, as well as the temperature and composition of the column 15. The fastest moving compounds exit the column 15 first, and then are followed by the remaining compounds in corresponding order. An electronic signal is generated when the compound hits the detector 19. The signal is analyzed by a data handler such as a computer to measure and identify the compound.

The hydrogen sensor 21 is installed in the environment (e.g. the laboratory) in which the GC 11 and the hydrogen generator 25 will be running. The hydrogen sensor 21 is placed in a location where hydrogen would naturally drift or accumulate in the event of a leak. For example, it should be placed at the high elevation point in a room that is well sealed. The hydrogen sensor 21 is configured to send a warning signal to the GC controller 23 when the amount of hydrogen sensed in the ambient environment is greater than a threshold level, indicating a leak in the GC system 10 somewhere. Although only a single hydrogen sensor 21 is shown in FIG. 1, more than one hydrogen sensor 21 may be placed in the environment. The hydrogen sensor 21 can also be located within the GC 11 itself. The hydrogen sensor can communicate with the GC controller 23 in any number of ways: over a physical wire or cable, or via a wireless or infrared transmission link.

The GC controller 23 is in communication with the hydrogen sensor 21, and with the hydrogen generator 25 as well. When the hydrogen sensor 21 indicates that the environment is clear of hydrogen, the GC 11 operates as usual. However, when the hydrogen sensor 21 indicates that the hydrogen concentration level in the ambient environment has exceeded the threshold, the GC controller 23 sends a shutdown signal to the hydrogen generator 25, via the communication link 27. This shutdown signal discontinues the flow of hydrogen from the hydrogen generator 25. The shutdown signal may also trigger a warning signal to the operator, a remote alarm, or other safety measures, and may also include discontinuing the power supply to the entire GC system 10.

The GC controller 23 and the hydrogen generator 25 can exchange other information regarding their operating condition and readiness over the communication link 27 as well. For example, the hydrogen generator 25 can send detailed information back to the GC controller 23 regarding the hydrogen generation rate, the amount of water left in the hydrogen generator 25, the hydrogen pressure level, any maintenance that might be required, or other information affecting the ability of the hydrogen generator 25 to produce and flow hydrogen carrier gas to the GC 11. The information sent back by the hydrogen generator 25 might even be as simple as a readiness indicator that is either high or low, indicating whether it is ready to flow hydrogen to the GC 11. The GC controller 23 uses this information to determine whether to start or stop an analysis.

The hydrogen generator 25 may have its own internal pressure detector that would indicate the existence of a leak within the hydrogen generator 25 itself. Upon detection of an internal leak, the hydrogen generator 25 should stop the flow and generation of hydrogen, and send a signal back to the GC controller 23 regarding the internal leak.

The GC controller 23 can also send information to the hydrogen generator 25. For example, the GC 11 may have its own internal pressure or internal hydrogen leak detector as well. The GC controller 23 can communicate to the hydrogen generator 25 to cease the flow and production of hydrogen when an internal leak is detected within the GC 11, or when the oven 17 is not heated to the correct temperature, or when the GC 11 is otherwise not ready to run a measurement. The hydrogen flow may be ceased when any component in the GC system 10 is non-responsive or in any potentially dangerous mode.

The physical form that the communication link 27 takes is not critical—it can be a physical wire or cable, or even a wireless or infrared transmission link. The format in which information is transferred over the communication link 27 is unimportant to the present invention as well.

The detector 19 is in communication with the GC controller 23. Other peripheral devices may be added to the GC system 10, too. The GC controller 23 should have communication links with all such devices, to send a shutdown signal in the event of a hydrogen leak. The communications with the detector 19 and other peripheral devices may also be as simple as a readiness indicator sent back when queried by the GC controller 23.

In an alternate embodiment, the hydrogen generator 25 is replaced with a hydrogen gas cylinder. The hydrogen gas cylinder has a valve that can be controlled electronically, so that the flow of hydrogen may be controlled with a signal from the GC controller 23. The hydrogen gas cylinder may also have its own internal leak or pressure detector that can signal the GC controller in the event of a hydrogen leak. Additionally, the hydrogen gas cylinder may also have the capability of signaling the GC controller that the filters need maintenance, or that the cylinder is approaching empty.

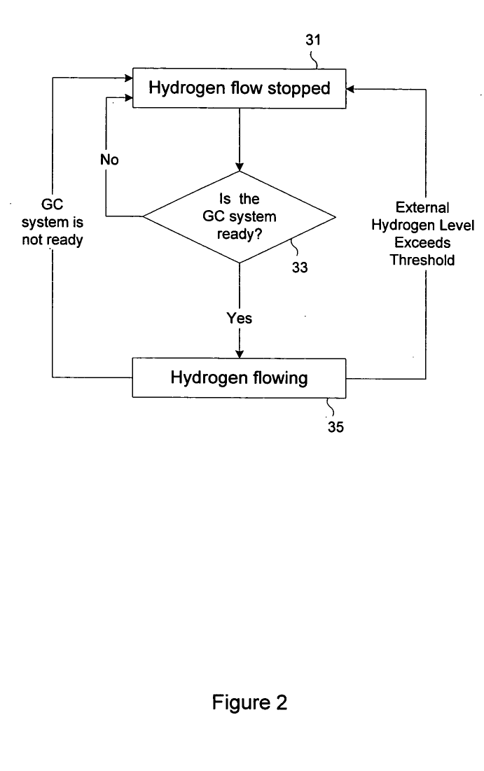

FIG. 2 shows a flow chart for an embodiment of a gas chromatography method using hydrogen carrier gas, made in accordance with the teachings of the present invention. Initially, the GC system 10 begins in step 31 (“no-flow mode”), where no hydrogen is flowing. No samples are running through the GC 11, the hydrogen generator 25 is not generating or flowing hydrogen carrier gas to the column 15, and the detector 19 (if one is being used) is not analyzing any samples.

Before an analysis begins, the GC controller 23 queries the hydrogen generator 25, the detector 19, and the GC 11 to see if every component within the GC system 10 is ready (step 33). If not, the GC system 10 remains in no-flow mode and the flow of hydrogen carrier gas remains stopped. When all components in the GC system 10 indicate they are ready, then hydrogen flow is established (step 35) and all components are prepared for sample analysis. While the hydrogen is flowing in step 35, the GC system 10 can run an analysis on a sample. Or, the GC system 10 can remain in a standby state of readiness, where the hydrogen carrier gas continues to flow through the GC 11 even though no samples are being analyzed at the moment.

While the hydrogen is flowing in step 35, the GC controller 23 continues to monitor the hydrogen sensor 21 and the other components in the GC system 10. When the hydrogen sensor 21 indicates that the detected hydrogen level exceeds a threshold, the GC controller 23 communicates a shutdown signal to the hydrogen generator 25 to immediately stop the flow and generation of hydrogen, and returns to the no-flow mode of step 31. As an additional safety measure, an alarm or warning signal to the operator might be triggered in shutdown mode to report the condition. The GC controller 23 can also put the components of the GC system 10 into a “safe mode” to reduce or eliminate the possibility of explosion. This safe mode will depend on the environment and application of the GC system 10. For example, it might include powering down some or all of the components within the GC system 10 to reduce the chance of any spark emissions that might ignite the leaked hydrogen.

Although the present invention has been described in detail with reference to particular embodiments, persons possessing ordinary skill in the art to which this invention pertains will appreciate that various modifications and enhancements may be made without departing from the spirit and scope of the claims that follow.

I claim:

1. A gas chromatography system for analyzing a sample, comprising:
a gas chromatograph (GC) using hydrogen carrier gas and controlled by a GC controller;
a hydrogen source supplying the hydrogen carrier gas to the GC;
a communication link between the GC and the hydrogen source; and
at least one hydrogen sensor that indicates to the GC controller when the sensed hydrogen level exceeds a threshold.

2. A gas chromatography system as in claim 1, wherein the GC controller sends a signal to the hydrogen source via the communication link, to stop the flow of hydrogen carrier gas when the sensed hydrogen level exceeds the threshold.

3. A gas chromatography system as in claim 2, wherein the hydrogen source includes a hydrogen generator.

4. A gas chromatography system as in claim 3, wherein the hydrogen generator exchanges information regarding its operating condition with the GC controller.

5. A gas chromatography system as in claim 4, wherein the GC controller puts the GC into a safe mode when the sensed hydrogen level exceeds the threshold.

6. A gas chromatography system as in claim 5, further comprising
a detector coupled to the GC for identifying the analyte, wherein the detector is in communication with the GC controller.

7. A gas chromatography system as in claim 2, wherein the hydrogen source includes a hydrogen gas cylinder.

8. A gas chromatography system as in claim 1, wherein the hydrogen sensor is external to the GC.

9. A gas chromatograph (GC) for analyzing a sample, comprising:
an injector for the purpose of receiving hydrogen carrier gas from a hydrogen source;
a GC controller having a port for the purpose of communicating with the hydrogen source; and
at least one hydrogen sensor in communication with the GC controller, indicating when the sensed hydrogen level exceeds a threshold,
wherein the GC controller sends a shutdown signal through the port to stop the flow of hydrogen carrier gas from the hydrogen source when the sensed hydrogen level exceeds the threshold.

10. A GC as in claim 9, further comprising:
a hydrogen source providing hydrogen carrier gas through the injector; and
a communication link between the GC controller and the hydrogen source,
wherein the hydrogen source stops the flow of hydrogen carrier gas upon receiving the shutdown signal from the GC controller.

11. A GC as in claim 10, wherein the hydrogen source generates hydrogen from water.

12. A GC as in claim 11, further comprising a detector for identifying the sample, wherein the detector is in communication with the GC controller.

13. A method, comprising:
providing a gas chromatograph (GC) using hydrogen carrier gas flowed from a hydrogen source, wherein the GC is run by a GC controller;
sensing a hydrogen level; and
stopping the flow of hydrogen carrier gas from the hydrogen source with a signal from the GC controller when the hydrogen level exceeds a threshold.

14. A method as in claim 13, further comprising communicating information regarding the hydrogen source to the GC controller.

15. A method as in claim 14, further comprising communicating information regarding the GC to the hydrogen source.

16. A method as in claim 15, wherein the hydrogen source generates hydrogen from water.

17. A method as in claim 16, wherein the hydrogen source includes a hydrogen gas cylinder.

18. A method as in claim 13, further comprising querying the hydrogen source for its status prior to starting the flow of hydrogen from the hydrogen source.

19. A method as in claim 18, further comprising sending a readiness indicator from the hydrogen source back to the GC controller.
